(19) United States
(12) Patent Application Publication
(10) Pub. No.: US 2004/0190554 A1
(43) Pub. Date: Sep. 30, 2004

(54) Fair multilevel arbitration system

(76) Inventor: William C. Galloway, Houston, TX (US)

Correspondence Address: WONG, CABELLO, LUTSCH, RUTHERFORD & BRUCCULERI,, P.C., 20333 SH 249, SUITE 600, HOUSTON, TX, 77070, US

(21) Appl. No.: 10/396,872

(22) Filed: Mar. 26, 2003

(51) Int. Cl. H04J 3/24

(52) U.S. Cl. 370/474

(57) ABSTRACT

An improved tree-structure arbitration system where each device which can request the bus or a path includes an arbitration wait timer. The arbitration wait timer is started when the particular device first requests to be connected to another device. During arbitration the arbitration wait timer value for each connected device which is requesting to be connected is received by an arbiter in an expander. The device with the oldest arbitration wait timer value is considered the winner. If there is another expander in sequence, this timer value is then provided as the timer value for that particular expander so that in the next level of arbitration that timer value is then used as the exemplary timer value for the expander in comparison with other targets present on that lower level expander. This protocol then continues until arbitration is finally completed. When arbitration is completed, the winning device resets or clears it arbitration wait timer. All the devices will continue counting during the entire arbitration period and thus the arbitration wait timer values would continue to accumulate if they did not win the arbitration, so that at the next arbitration they would have a better chance of being selected.

### BACKGROUND OF THE INVENTION

1. Field of the Invention

The invention generally relates to arbitration systems and more particularly to an arbitration system for a tree-structured bus architecture.

2. Description of the Related Art

Modern computer systems are becoming ever more capable as time passes. One of the limitations in current computer systems has been the disk drives used in direct attach storage. In lower cost computers the disk drives have been connected through an IDE (integrated drive electronics) or ATA (AT Attachment) parallel cable. This cable has a limited length and a limited number of disk drives, normally two, that can be attached. To add more drives, more controllers and cables must be added, which increases system cost. The width of the cable and its limited length has created packaging problems for the installation of a large number of disk drives, which problem is exacerbated if additional controllers and cables are added. The other leading alternative is SCSI (Small Computer System Interface). SCSI also uses a wide cable with limited lengths. However, SCSI can provide more disk drives for any given controller so the number of drives is not as limited. Again, the cable length and width creates problems. All of this must be balanced with the desire to have as many high performance disk drives available as possible to increase overall system performance.

To address some of these problems a consortium was formed to develop the SATA or Serial ATA Specification. The specifications can be obtained at the website serialata.org. The current specifications include Serial ATA, Revision 1.0a dated Jan. 7, 2003 and Serial ATA II: Extensions to Serial ATA 1.0, Revision 1.0, dated Oct. 16, 2002, both of which are hereby incorporated by reference. The SATA specification provides for a very small cable effectively operating as a bidirectional serial link at a very high speed such as 1.5 Gbps or 3.0 Gbps. Because of the small cable sizes and potentially slightly longer lengths, the use of SATA drives is expected to proliferate in the near future, resulting in very large economies of scale. However, SATA drives are port to port devices only, so they are not as useful in more powerful systems such as servers where many drives might be required. Further, they use the IDE or ATA communications protocol, which is not conventionally used by servers, as they conventionally use SCSI signaling protocols.

To address this shortcoming in servers, another consortium developed the SAS or Serial Attached SCSI specification. Layer 0 of an SAS environment is compatible with an SATA environment, therefore allowing use of the high volume SATA drives. The improvements of the SAS specification for server use have primarily been the addition and use of various SCSI commands and the inclusion of expanders to allow additional drives to be controlled by a given processor. The expanders can be attached in a tree structure to allowing inclusion of a very large number of drives or targets. An expander essentially operates as a crossbar switch between its various ports, thus creating the point to point, dedicated link need for SATA or SAS drives.

It was desired to be fair in the arbitration scheme to obtain control of the desired path. The original proposal for expander arbitration was to use a round robin technique in each expander, so that priority rotated around the ports of the particular expander. However, it was determined that when multiple expanders are connected in a tree structure, requests from an initiator to a target drive located several layers down the tree structure rapidly became unfair. This happened because the initiator would have to win the arbitration slot in the round robin in the first level expander. The first level expander would then have to win the round robin arbitration in the second level expander to allow the initiator to obtain priority. This would continue until the expanders were traversed to reach the particular target drive. Thus it can be seen that the initiator priority rapidly dropped as additional expanders were added. This was a very undesirable situation as it would effectively starve the initiator in many circumstances.

Therefore it would be desirable to have an arbitration scheme which is more inherently fair in a multi-tiered or tree-structured bussing situation.

### BRIEF SUMMARY OF THE INVENTION

In an improved tree-structure arbitration system each device which can request the bus or a path includes an arbitration wait timer. The arbitration wait timer is started when the particular device first requests to be connected to another device. During arbitration the arbitration wait timer value for each connected device which is requesting to be connected is received by an arbiter in an expander. The device with the highest arbitration wait timer value is considered the winner. If there is another expander in sequence, this timer value is then provided as the timer value for that particular expander so that in the next level of arbitration that timer value is then used as the exemplary timer value for the expander in comparison with other targets present on that lower level expander. This protocol then continues until arbitration is finally completed. When arbitration is completed, the winning device resets or clears it arbitration wait timer. All the devices will continue counting during the entire arbitration period and thus the arbitration wait timer values would continue to accumulate if they did not win the arbitration, so that at the next arbitration they would have a better chance of being selected.

This particular scheme is significantly fairer than a multi-level round robin as originally proposed for SAS and inherently allows the device which has been waiting the longest to be granted arbitration priority. The scheme is thus inherently fair over any number of levels and does not have the cascading problem described in the background.

### BRIEF DESCRIPTION OF THE SEVERAL VIEWS OF THE DRAWINGS

FIG. 1 illustrates a block diagram of a computer system utilizing an SAS system according to an embodiment of the present invention.

FIG. 2 is a more detailed version of FIG. 1 indicating the various initiators, expanders, and targets and their arbitration wait timers according to an embodiment of the present invention.

FIG. 3 provide further detail of the arbiters of FIG. 2.

### DETAILED DESCRIPTION OF PREFERRED EMBODIMENT

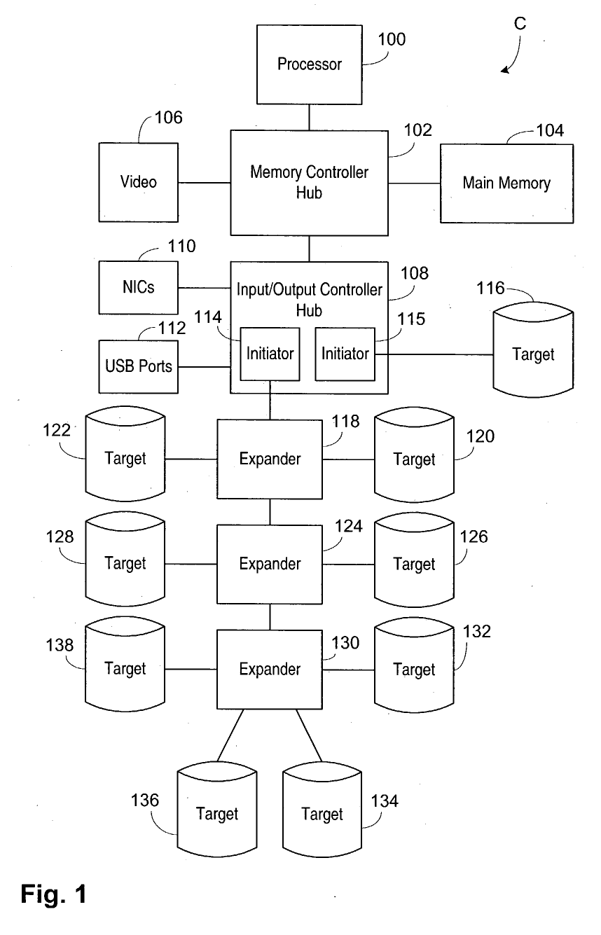

Referring now to FIG. 1, a computer C generally includes a Serial Attached SCSI (SAS) system including arbitration according to an embodiment of the present invention. A processor 100 is connected to a memory controller hub (MCH) 102. In turn the memory controller hub 102 is connected to main memory 104 and a video system 106. In this manner of the processor 100 can address the main memory 104 through the memory controller hub 102. The video control system 106 can also access the main memory 104 if desired and can be accessed by the processor 100. The memory controller hub 102 is connected to an input/output controller hub (IOCH) 108. The IOCH 108 is connected to or includes a plurality of network interface ports 110. The network interface ports can be typical wired Ethernet ports, can be wireless Ethernet ports or can be other wireless protocols such as Bluetooth. A series of USB ports 112 are also connected to the IOCH 108 to provide peripheral expansion for devices such as keyboards, printers, scanners and the like. This is an exemplary computer architecture and many variations can be used, such as those using North and South bridges, multiple processors, multiple IOCHs, single chip implementations and so on.

More relevant to the present invention, initiators 114 and 115 are located in the IOCH 108. Preferably initiators 114 and 115 are compatible with the SAS standard. In the illustrated embodiment, a first target drive 116 is connected directly to the initiator 115. An expander 118, again preferably according to the SAS standard, is connected to the initiator 114. The expander provides the capability to attach additional targets or hard drives for control by the initiator 114. To this end, targets 120 and 122 are shown connected to the expander 118. In order to allow further expansion, a second expander 124 is shown connected to the first expander 118. The second expander 124 additionally includes targets 126 and 128 in the illustrated embodiment. Yet a third expander 130 is connected to the second expander 124. In the illustrated embodiment this is the final expander in the tree and it is connected to targets 132, 134, 136 and 138. Preferably all of the targets are SAS compatible targets. The current draft of the SAS specification is Revision 3c dated Feb. 9, 2003 and is Project T10 1562-D of the incits T10 Technical committee (T10.org). The current specification is available from the T10 committee via the website and is hereby incorporated by reference.

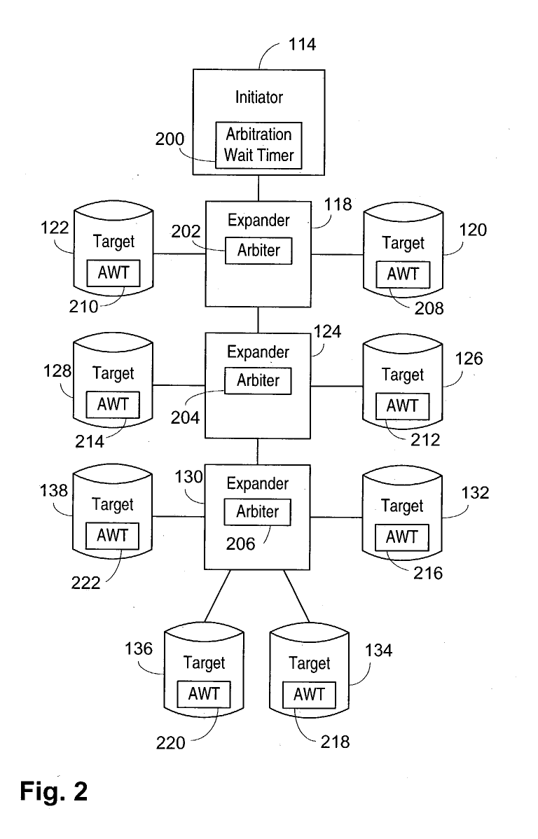

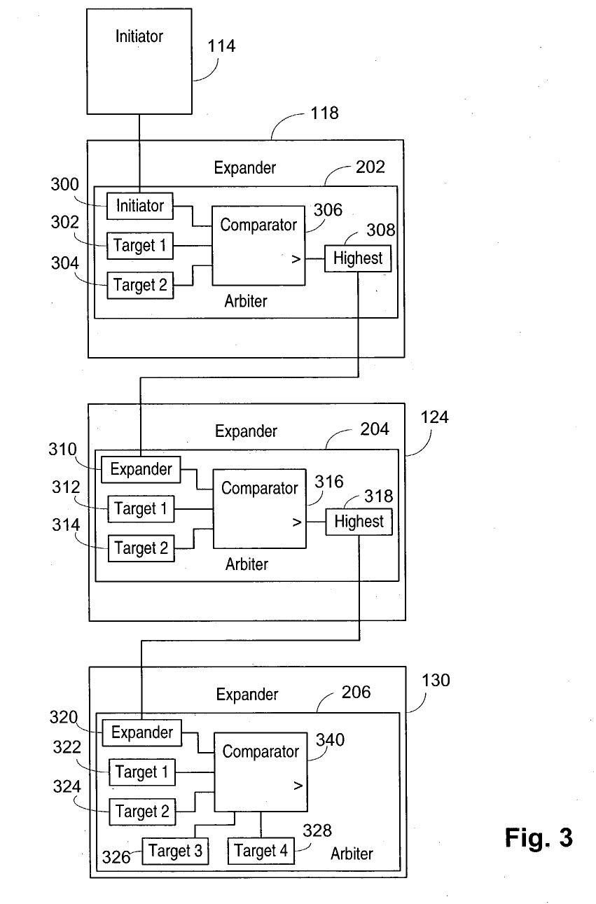

Referring now to FIG. 2, the initiator 114 is shown as having an arbitration wait timer (AWT) 200. The arbitration wait timer 200 is a timer that is commenced when the initiator 114 first desires to obtain access to a target in the expander chain or otherwise arbitrate. The timer 200 can be commenced at a zero or can be loaded with a non-zero value to bias arbitration in favor of the particular device. Each target 120, 122, 126, 128, 132-138 also includes an arbitration wait timer 208-222, respectively. Preferably, each arbitration wait timer has a 16 bit value, the most significant bit indicating a scale of microseconds or milliseconds for the remaining 15 bits, the scale changing from microseconds to milliseconds when a full scale microseconds reading is reached. Each expander 118, 124, and 130 includes an arbiter 202, 204, and 206, respectively, to arbitrate for a particular path present in that expander 118, 124, and 130. A device requests to make a connection by sending an OPEN frame. Included in the OPEN frame is the arbitration wait timer value. The related arbiter captures the arbitration wait timer value from the OPEN frame and places it into an AWT for that port or device in the arbiter. Please refer to FIG. 3 for an illustration of these timers. When arbitration is commenced in the expander 118, the arbitration wait timers for each of the particular targets 208, 210 and 200 are compared in the arbiter 202. The arbitration wait timer with the highest value, i.e., an indication that this device has been waiting the longest to win arbitration, assuming they all start at an equal value, has its value placed in the OPEN frame sent by the winning device. The updated OPEN frame is then sent by the expander 118 to the next expander 124 for that arbitration. If the AWT values for two devices are identical, the device with the higher SAS address wins the arbitration. The expander 124 arbitrates with the expander 118 value and the targets 126 and 128 and their respective arbitration wait timer 212 and 214 values. The winner of the arbitration in the expander 124 has its value used in another forwarded OPEN frame and then in the arbitration in the expander 130.

It is understood that this is an example based on an arbitration from the initiator 114 downward to a target device such as target 134. It is understood that a similar chain would occur in an opposite direction should a target request arbitration to reconnect to the initiator 114. That logic has not been shown to ease understanding but is presumed to be present in the embodiment. It is also understood that the arbitration may stop at an intermediate level if the target is connected to the intermediate expander. It is further understood that several arbitrations could occur simultaneously in an expander if the path requests did not overlap, such as requests to different output ports. This reason alone means that there are actually a large number of arbiters in each expander, such as one for each output port. However, there would only be one AWT for each input port with each arbiter having access to each input AWT. It is also understood that an arbitration decision in a particular expander can be reversed. If arbitrations for complementary resources (an initiator and target requesting each other) exist, one proceeding downward, and one proceeding upward, they will meet in the middle and the losing direction will back off and arbitration will continue in the winning direction. An item not shown for simplicity is that each initiator can have multiple ports, with each port having an AWT. The additional complexities of the arbiter for these situations are also not shown to ease understanding.

While the above has been for a case with multiple expanders, the arbitration also occurs for the direct connection between an initiator 115 and a target 116. In this case, the arbitration only occurs if they are simultaneously requesting, but then the above highest arbitration wait time value and then the address tie breaker apply, with each device independently performing a comparison between the received time value and its own sent value and determining the winner. A similar process occurs between an expander and a connected device should OPEN frames cross.

Referring now to FIG. 3, a more detailed operation and design of the arbiters is shown. Referring then to expander 118 and its related arbiter 202, three port arbitration wait timers are illustrated, namely initiator AWT 300, target one AWT 302, and target two AWT 304. Only three AWTs are shown for simplicity. The actual number would equal the number of ports for that particular expander. These arbitration wait timers contain the incrementing values of the wait timer values provided by the related device in its OPEN frame. These values shadow those in the related devices because the device timers also continue to increment. These timers 300, 302, 304 are connected to a comparator 306 which determines which of the timer values is the greatest or oldest. This value is provided to the highest register 308 to indicate which device which has been waiting the longest, again assuming no bias. This value is inserted as the arbitration wait time value in the OPEN frame from the winning device. In the illustrated embodiment this updated OPEN frame is provided to the arbiter 204 in expander 124 and the arbitration wait time value is placed into the expander AWT 310, which is then compared with related targets one and two AWTs 312 and 314. The comparator 316 compares the values and provides the oldest or highest value to highest timer register 318. In the illustrated embodiment the expander 124 would use this value in the OPEN frame which is being forwarded, with the value being placed in the expander AWT 320 in the arbiter 206 of expander 130. Similarly, AWTs 322, 324, 326 and 328 are utilized for targets one, two, three and four in expander 130. The comparator 340 determines which of the values is the highest, i.e., indicating the oldest, and this AWT value is placed in the OPEN frame, which this time is provided to the addressed target device, such as target device 134. The target device 134 returns an OPEN_ACCEPT primitive, which returns on the path taken by the winning OPEN frame to the initiator 114. As the OPEN_ACCEPT primitive travels to the winning initiator 114, each expander 118, 124 and 130 clears the winning AWT 300, 310 and 320 and the initiator 114 clears its AWT 200. As the initiator 114 was the winner, and the remaining devices were not winners, the other AWTs in the remaining devices and their related AWTs in the respective arbiters proceed to further increment and have been further incrementing during the entire arbitration operation. Thus, the true timer value would continue to be kept until a particular device finally wins arbitration.

Thus, this is a very fair arbitration system which allows the device which has been longest requesting arbitration to obtain priority in a system of serial expansion and arbitration at each level of expansion.

Thus description has used incrementing timers and greatest value comparisons, but it is understood that decrementing timers and least value comparisons could be done. While the invention has been disclosed with respect to a limited number of embodiments, numerous modifications and variations will be appreciated by those skilled in the art. It is intended, therefore, that the following claims cover all such modifications and variations that may fall within the true spirit and scope of the invention.

1. An arbitration device for devices requesting use of a shared resource, the arbitration device comprising:
a plurality of timers, each associated with a device requesting use of the shared resource and containing a value indicative of the time since the device requested use of the shared resource; and
an arbiter connected to each of said plurality of timers and selecting the device associated with the longest time since requesting use of the shared resource as the winner of the arbitration.

2. The arbitration device of claim 1, wherein each device requesting use of the shared resource supplies an OPEN frame, said OPEN frame including a value representing the time since the device requested use of the shared resource, the arbitration device further comprising:
circuitry for receiving an OPEN frame from a device and placing the time value in the associated timer in said plurality of timers.

3. The arbitration device of claim 2, wherein the arbitration device may be connected to another arbitration device, the arbitration device further comprising:
circuitry to store the value of the winner device timer in the OPEN frame of the winner device for provision to the other arbitration device.

4. The arbitration device of claim 1, wherein the timer associated with the winning device is cleared after said arbiter determines the winner.

5. The arbitration device of claim 4, wherein each of said plurality of timers continues to time until the associated device is the winner.

6. A device for use with an arbitration device which arbitrates based on time since a device has requested use of a shared resource, the device comprising:
a timer containing a value indicative of the time since the device requested use of the shared resource;
a circuit connected to said timer for developing a frame requesting use of the shared resource, said circuit including said timer value in said frame; and
a circuit connected to said frame developing circuit for transmitting said frame.

7. The device of claim 6, further comprising:
a circuit connected to said timer for receiving an indication that the device is the winner of an arbitration for the shared resource and clearing said timer on receipt of said winning indication.

8. A storage system utilizing a shared resource, the storage system comprising:
first and second devices, each device including:
a timer containing a value indicative of the time since the device requested use of the shared resource;
a circuit connected to said timer for developing an OPEN frame requesting use of the shared resource, said circuit including said timer value in said frame; and
a circuit connected to said frame developing circuit for transmitting said OPEN frame; and
an arbitration device connected to said first and second devices, the arbitration device including:
first and second timers, associated with said first and second devices, respectively, and containing a value indicative of the time since the device requested use of the shared resource; and
an arbiter connected to each of said plurality of timers and selecting the device associated with the longest time since requesting use of the shared resource as the winner of the arbitration.

9. The storage system of claim 8, the arbitration device further including:
circuitry for receiving an OPEN frame from a device and placing the time value in the associated timer of said first and second timers.

10. The storage system of claim 8, wherein said arbitration device timer associated with the winning device is cleared after said arbiter determines the winner.

11. The storage system of claim 10, wherein each of said timers continues to time until the associated device is the winner.

12. The storage system of claim 8, said first and second devices each further including:
a circuit connected to said timer for receiving an indication that the device is the winner of an arbitration for the shared resource and clearing said timer on receipt of said winning indication, and
said arbitration device further including:
a circuit for providing an indication that the device is the winner of an arbitration to the winning device.

13. A storage system utilizing a shared resource, the storage system comprising:
first, second and third devices, each device including:
a timer containing a value indicative of the time since the device requested use of the shared resource;
a circuit connected to said timer for developing an OPEN frame requesting use of the shared resource, said circuit including said timer value in said frame; and
a circuit connected to said frame developing circuit for transmitting said OPEN frame; and
first and second arbitration devices, each arbitration device including:
first and second timers, each associated with a connected device and containing a value indicative of the time since the device requested use of the shared resource; and
an arbiter connected to each of said plurality of timers and selecting the device associated with the longest time since requesting use of the shared resource as the winner of the arbitration,
wherein said first and second devices are connected to said first arbitration device and said third device and said first arbitration device are connected to said second arbitration device, and
wherein said first arbitration device further includes:
circuitry to forward the value of the winner device to said second arbitration device.

14. The storage system of claim 13, each arbitration device further including:
circuitry for receiving an OPEN frame from a device and placing the time value in the associated timer of said first and second timers, and
wherein said circuitry to forward stores said value in the OPEN frame of the winner device and provides the altered OPEN frame to said second arbitration device.

15. The storage system of claim 13, wherein said arbitration device timer associated with the winning device is cleared after said arbiter determines the winner.

16. The storage system of claim 15, wherein each of said timers continues to time until the associated device is the winner.

17. The storage system of claim 13, said first, second and third devices each further including:
a circuit connected to said timer for receiving an indication that the device is the winner of an arbitration for the shared resource and clearing said timer on receipt of said winning indication,
each said arbitration device further including:
a circuit for providing an indication that the device is the winner of an arbitration to the winning device, and
said first arbitration device further including:
a circuit connected to said winner device storage timer for receiving an indication that the device is the winner of an arbitration for the shared resource and clearing said timer on receipt of said winning indication.

18. A system utilizing a shared resource, the system comprising:
a computer system including:
a processor;
main memory;
a bridge circuit connected to said processor and said main memory; and
an initiator device coupled to said bridge circuit;
a target device, said initiator and said target device each including:
a timer containing a value indicative of the time since the device requested use of the shared resource;
a circuit connected to said timer for developing an OPEN frame requesting use of the shared resource, said circuit including said timer value in said frame; and
a circuit connected to said frame developing circuit for transmitting said OPEN frame; and
an arbitration device connected to said initiator and target devices, the arbitration device including:
first and second timers, associated with said first and second devices, respectively, and containing a value indicative of the time since the device requested use of the shared resource; and
an arbiter connected to each of said plurality of timers and selecting the device associated with the longest time since requesting use of the shared resource as the winner of the arbitration.

19. The system of claim 18, the arbitration device further including:
circuitry for receiving an OPEN frame from a device and placing the time value in the associated timer of said first and second timers.

20. The system of claim 18, wherein said arbitration device timer associated with the winning device is cleared after said arbiter determines the winner.

21. The system of claim 20, wherein each of said timers continues to time until the associated device is the winner.

22. The system of claim 18, wherein each of said initiator and target devices each further includes:
a circuit connected to said timer for receiving an indication that the device is the winner of an arbitration for the shared resource and clearing said timer on receipt of said winning indication, and
said arbitration device further including:
a circuit for providing an indication that the device is the winner of an arbitration to the winning device.

23. A system utilizing a shared resource, the system comprising:
a computer system including:
a processor;
main memory;
a bridge circuit connected to said processor and said main memory; and
an initiator device coupled to said bridge circuit;
first and second target devices, each initiator and target device including:
a timer containing a value indicative of the time since the device requested use of the shared resource;
a circuit connected to said timer for developing an OPEN frame requesting use of the shared resource, said circuit including said timer value in said frame; and
a circuit connected to said frame developing circuit for transmitting said OPEN frame; and
first and second arbitration devices, each arbitration device including:
first and second timers, each associated with a connected device and containing a value indicative of the time since the device requested use of the shared resource; and
an arbiter connected to each of said plurality of timers and selecting the device associated with the longest time since requesting use of the shared resource as the winner of the arbitration,
wherein said initiator device and said first target device are connected to said first arbitration device and said second target device and said first arbitration device are connected to said second arbitration device, and
wherein said first arbitration device further includes:
circuitry to forward the value of the winner device for provision to said second arbitration device.

24. The system of claim 23, each arbitration device further including:
circuitry for receiving an OPEN frame from a device and placing the time value in the associated timer of said first and second timers, and
wherein said circuitry to forward stores said value in the OPEN frame of the winner device and provides the altered OPEN frame to said second arbitration device.

25. The system of claim 23, wherein said arbitration device timer associated with the winning device is cleared after said arbiter determines the winner.

26. The system of claim 25, wherein each of said timers continues to time until the associated device is the winner.

27. The system of claim 23, said initiator device and said first and second target devices each further including:
a circuit connected to said timer for receiving an indication that the device is the winner of an arbitration for the shared resource and clearing said timer on receipt of said winning indication,
each said arbitration device further including:
a circuit for providing an indication that the device is the winner of an arbitration to the winning device, and
said first arbitration device further including:
a circuit connected to said winner device storage timer for receiving an indication that the device is the winner of an arbitration for the shared resource and clearing said timer on receipt of said winning indication.

28. A computer system utilizing a shared resource, the computer system comprising:
a processor;
main memory;
a bridge circuit connected to said processor and said main memory; and
an initiator device coupled to said bridge circuit; said initiator device including:
a timer containing a value indicative of the time since the device requested use of the shared resource;
a circuit connected to said timer for developing an OPEN frame requesting use of the shared resource, said circuit including said timer value in said frame; and
a circuit connected to said frame developing circuit for transmitting said OPEN frame.

29. The computer system of claim 28, said initiator device further including:
a circuit connected to said timer for receiving an indication that the device is the winner of an arbitration for the shared resource and clearing said timer on receipt of said winning indication.

30. An arbitration method for devices requesting use of a shared resource, the arbitration method comprising:
timing the periods since each device requested use of the shared resource; and
selecting the device associated with the longest time since requesting use of the shared resource as the winner of the arbitration.

31. The arbitration method of claim 30, wherein each device requesting use of the shared resource supplies an OPEN frame, said OPEN frame including a value representing the time since the device requested use of the shared resource, the arbitration method further comprising:
receiving an OPEN frame from a device and using the time value as the starting value for the period since the device requested use of the shared resource.

32. The arbitration method of claim 30 further comprising:
storing the value of the winner device timing value for use in another arbitration.

33. The arbitration method of claim 30 further comprising stopping the timing associated with the winning device after selecting the winner.

34. The arbitration method of claim 33 further comprising continuing to time until the associated device is the winner.

35. A method for use with an arbitration device which arbitrates based on time since a device has requested use of a shared resource, the method comprising:
timing a period since a device requested use of the shared resource;
developing a frame requesting use of the shared resource and including said time value in said frame; and
transmitting said frame.

36. The method of claim 35, further comprising:
receiving an indication that the device is the winner of an arbitration for the shared resource and stopping the timing on receipt of said winning indication.

37. A method for utilizing a shared resource, the method comprising:
in each of first and second devices:
timing the period since the device requested use of the shared resource;
developing an OPEN frame requesting use of the shared resource and including said time value in said frame; and
transmitting said OPEN frame; and
in an arbitration device connected to said first and second devices:
timing the periods since each of said first and second devices requested use of the shared resource; and
selecting the device associated with the longest time since requesting use of the shared resource as the winner of the arbitration.

38. The method of claim 37, the arbitration device further:
receiving an OPEN frame from a device and using the time value as the starting value for the period since requesting use of the shared resource.

39. The method of claim 37, wherein said arbitration device further stops the timing associated with the winning device after selecting the winner.

40. The method of claim 39, further continuing to time until the associated device is the winner.

41. The method of claim 37, said first and second devices each further:
receiving an indication that the device is the winner of an arbitration for the shared resource and stopping the timing on receipt of said winning indication, and
said arbitration device further:
providing an indication that the device is the winner of an arbitration to the winning device.

42. A method for utilizing a shared resource, the method comprising:
in each of first, second and third devices:
timing the period since the device requested use of the shared resource;
developing an OPEN frame requesting use of the shared resource and including said timer value in said frame; and
transmitting said OPEN frame; and
in each of first and second arbitration devices:
timing the periods since each connected device requested use of the shared resource; and
selecting the device associated with the longest time since requesting use of the shared resource as the winner of the arbitration,
wherein said first and second devices are connected to said first arbitration device and said third device and said first arbitration device are connected to said second arbitration device, and
wherein said first arbitration device further:
replicates the time value of the winner device for provision to said second arbitration device.

43. The method of claim 42, each arbitration device further:
receiving an OPEN frame from a device and using the time value as the starting value for the period since requesting use of the shared resource, and
wherein said first arbitration device stores said value in the OPEN frame of the winner device and provides the altered OPEN frame to said second arbitration device.

44. The method of claim 42, wherein said arbitration device further stops the timing after said arbiter selects the winner.

45. The method of claim 44, further continuing to time until the associated device is the winner.

46. The method of claim 42, said first, second and third devices each further:
receiving an indication that the device is the winner of an arbitration for the shared resource and stopping the timing on receipt of said winning indication,
each said arbitration device further:
providing an indication that the device is the winner of an arbitration to the winning device, and
said first arbitration device further:
receiving an indication that the device is the winner of an arbitration for the shared resource and stopping the timing on receipt of said winning indication.

47. A device which arbitrates based on time since a device has requested use of a shared resource, the device comprising:
a timer containing a value indicative of the time since the device requested use of the shared resource;
a circuit connected to said timer for developing a frame requesting use of the shared resource, said circuit including said timer value in said frame; and
a circuit connected to said frame developing circuit for transmitting said frame.

48. The device of claim 47, further comprising:
a circuit connected to said timer for receiving an indication that the device is the winner of an arbitration for the shared resource and clearing said timer on receipt of said winning indication.

49. The device of claim 48, further comprising:
a circuit to compare said timer value in said transmitted frame and a timer value in a received frame and develop said winning indication.

50. A storage system utilizing a shared resource, the storage system comprising:
first and second devices, each device connected to the other and each including:
a timer containing a value indicative of the time since the device requested use of the shared resource;
a circuit connected to said timer for developing an OPEN frame requesting use of the shared resource, said circuit including said timer value in said frame; and
a circuit connected to said frame developing circuit for transmitting said OPEN frame.

51. The storage system of claim 50, said first and second devices each further including:
a circuit connected to said timer for receiving an indication that the device is the winner of an arbitration for the shared resource and clearing said timer on receipt of said winning indication.

52. The storage system of claim 51, said first and second devices each further including:
a circuit to compare said timer value in said transmitted frame and a timer value in a received frame and develop said winning indication.

52. A system utilizing a shared resource, the system comprising:
a computer system including:
a processor;
main memory;
a bridge circuit connected to said processor and said main memory; and
an initiator device coupled to said bridge circuit; and
a target device, said initiator and said target device each connected to the other and each including:
a timer containing a value indicative of the time since the device requested use of the shared resource;
a circuit connected to said timer for developing an OPEN frame requesting use of the shared resource, said circuit including said timer value in said frame; and
a circuit connected to said frame developing circuit for transmitting said OPEN frame.

53. The system of claim 52, wherein each of said initiator and target devices each further includes:
a circuit connected to said timer for receiving an indication that the device is the winner of an arbitration for the shared resource and clearing said timer on receipt of said winning indication, and

54. The system of claim 53, said initiator and target devices each further including:
a circuit to compare said timer value in said transmitted frame and a timer value in a received frame and develop said winning indication.

55. A method for utilizing a shared resource, the method comprising:
in each of first and second devices:
timing the period since the device requested use of the shared resource;
developing an OPEN frame requesting use of the shared resource and including said time value in said frame; and
transmitting said OPEN frame.

56. The method of claim 55, said first and second devices each further:
receiving an indication that the device is the winner of an arbitration for the shared resource and stopping the timing on receipt of said winning indication.

57. The method of claim 55, said first and second devices each further:
comparing said timer value in said transmitted frame and a timer value in a received frame and developing said winning indication.
